(19) United States
(12) Patent Application Publication
(10) Pub. No.: US 2024/0386456 A1
(43) Pub. Date: Nov. 21, 2024

(54) INFORMATION PROCESSING DEVICE

(71) Applicant: TOYOTA JIDOSHA KABUSHIKI KAISHA, Toyota-shi (JP)

(72) Inventors: Yohei NAKANISHI, Nagoya-shi (JP); Yu HAMADA, Nagoya-shi (JP); Kenta KAWASHIMA, Nagoya-shi (JP); Yuichi MUKASA, Kawaguchi-shi (JP); Keisuke KONDO, Nagoya-shi (JP)

(73) Assignee: TOYOTA JIDOSHA KABUSHIKI KAISHA, Toyota-shi (JP)

(21) Appl. No.: 18/597,066

(22) Filed: Mar. 6, 2024

(30) Foreign Application Priority Data
May 17, 2023 (JP) 2023-081212

(51) Int. Cl. G06Q 30/0235; G06Q 10/20

(52) U.S. Cl. CPC G06Q 30/0235; G06Q 10/20

(57) ABSTRACT

In the information processing device, the control unit acquires a recommended time period in which maintenance of the leased vehicle is recommended at a predetermined station. The control unit transmits information including the recommended time period to a terminal associated with the user of the leased vehicle. The control unit outputs information of the reward provided to the user when the maintenance of the leased vehicle is performed at a predetermined station within the recommended time period.

### CROSS-REFERENCE TO RELATED APPLICATION

This application claims priority to Japanese Patent Application No. 2023-081212 filed on May 17, 2023, incorporated herein by reference in its entirety.

### BACKGROUND

### 1. Technical Field

The present disclosure relates to an information processing device.

### 2. Description of Related Art

There is known a method of selling fuel to leased vehicles, in which a discount rate of fuel charges is greater for a leased vehicle regarding which oil changing is included as a maintenance item of a lease contract, as compared to that of a leased vehicle regarding which oil changing is not included as a maintenance item of the lease contract (e.g., see Japanese Unexamined Patent Application Publication No. 2020-38708 (JP 2020-38708 A)).

### SUMMARY

An object of the present disclosure is to provide technology that is effective in suppressing decrease in residual value of a vehicle, while suppressing excessive maintenance from being performed on the vehicle.

One aspect of the present disclosure is an information processing device. In this case, the information processing device includes a control unit configured to execute acquiring of a recommended time period for a leased vehicle that is recommended to undergo maintenance at a predetermined station,
transmitting of information including the recommended time period to a terminal associated with a user of the leased vehicle, and
outputting of information of a reward provided to the user when maintenance of the leased vehicle is performed at the predetermined station within the recommended time period.

Another aspect of the present disclosure may be an information processing method in which a computer executes the above-described processing, a program for causing the computer to execute the information processing method, or a non-transitory storage medium storing the program.

According to the present disclosure, technology that is effective in suppressing decrease in residual value of a vehicle, while suppressing excessive maintenance from being performed on the vehicle, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a vehicle management system;

FIG. 2 is a block diagram illustrating a configuration of an in-vehicle device and a server included in the vehicle management system;

FIG. 3 is a diagram illustrating an example of information stored in a vehicle DB;

FIG. 4 is a diagram illustrating exemplary data stored in a maintenance DB;

FIG. 5 is a flowchart illustrating a process flow executed by the server in response to reception of the vehicle information. and

FIG. 6 is a flowchart illustrating a flow of a process executed by a server triggered by completion of maintenance.

### DETAILED DESCRIPTION OF EMBODIMENTS

As a vehicle leasing service, a leasing service including a maintenance cost is known. In such a lease service, the maintenance time is determined in advance for each item. For example, for the engine oil, the maintenance timing is determined so that the engine oil is replaced at a constant traveling distance or at a constant period.

However, depending on the manner of driving the vehicle by the user, a predetermined maintenance time may not be appropriate. For example, in a vehicle of a user that performs an operation in which engine oil is hardly deteriorated, there is a possibility that the engine oil does not deteriorate to an extent that the engine oil needs to be replaced within a predetermined constant traveling distance or a predetermined period of time. In such a case, if the oil change is performed according to a predetermined constant travel distance or a predetermined period of time, excessive maintenance may be performed, which may increase the burden on the lease service provider or cause excessive consumption of engine oil resources.

Therefore, a method of flexibly determining the maintenance time according to the vehicle state is conceivable. However, when such a method is adopted, if the actual maintenance is not performed at the maintenance time determined according to the vehicle state, there is a possibility that the market value (residual value) of the vehicle is lowered. In particular, in a vehicle subject to lease, a decrease in the residual value may make it difficult to find a borrower or a buyer of the vehicle after returning. Therefore, it is necessary to make an effort to suppress a decrease in the residual value while suppressing excessive maintenance.

On the other hand, in the information processing device according to the present disclosure, the control unit acquires a recommended time period in which it is recommended to receive maintenance of the leased vehicle at a predetermined station. The predetermined station is a maintenance factory operated by a lease service provider or a maintenance factory operated by a contractor commissioned by a lease service provider. The recommended time period is a period determined according to the state of the leased vehicle. Obtaining such a recommended time period includes, in one example, determining whether a degree of deterioration of a vehicle component corresponding to each of a plurality of items for maintenance exceeds a predetermined threshold according to a vehicle state periodically acquired from a leased vehicle, and determining a recommended time period for an item corresponding to a vehicle component whose degree of deterioration exceeds the predetermined threshold.

The control unit of the information processing device according to the present disclosure transmits information including the acquired recommended time period to a terminal associated with the user of the leased vehicle. The information including the recommended time period may be, in one example, information that prompts the leased vehicle to be stored in a predetermined station within the recommended time period. The terminal associated with the user of the leased vehicle is, for example, a terminal used by the user.

The control unit of the information processing device according to the present disclosure outputs the information of the reward provided to the user when the maintenance of the leased vehicle is performed at a predetermined station within the recommended time period. The reward may be any reward as long as the user can be motivated to store the leased vehicle at a predetermined station within the recommended time period. In one example, the reward may be a discount on the lease fee. As another example, the reward may be a coupon, a point, a gift certificate, or the like.

Here, the size of the reward may be determined in accordance with the date on which the maintenance of the leased vehicle is received at a predetermined station. In an example, the control unit may increase the reward as the date on which the maintenance of the leased vehicle is received at a predetermined station is closer to a specific date (recommended date) within the recommended time period. The recommended date may be the date determined voluntarily by the lease service provider, the date on which a given station can accept maintenance (the date on which the work schedule is free), the first day of the recommended time period, or the last day of the recommended time period. Note that the recommended date may be flexibly changed according to the embodiment.

Further, the size of the reward may be determined in accordance with past performance. In an example, the control unit may increase the reward as the number of times the maintenance of the leased vehicle is performed at a predetermined station within the recommended time period increases.

Further, the size of the above-described reward may be determined in accordance with an item of maintenance received by the leased vehicle at a predetermined station. In one example, the control unit may increase the reward as the importance of the maintenance item received by the leased vehicle at the predetermined station within the recommended time period increases. The importance level may be an importance level in the security standard. Also, the importance may be determined in accordance with the degree of influence on the remaining value of the leased vehicle, or may be determined in accordance with the price of the parts to be replaced in accordance with the execution of maintenance.

The above-described determination of the reward by the various methods may be performed each time maintenance of the leased vehicle is performed at a predetermined station within the recommended time period, or may be performed at the end of the lease period (at the time of returning the leased vehicle).

The outputting of the information of the reward in the information processing device according to the present disclosure may include presenting the information of the reward to the operator through a display included in the information processing device, and/or transmitting the information of the reward to the terminal of the user.

According to the present disclosure, it is possible to encourage a user to receive maintenance of a leased vehicle within a recommended time period. As a result, it is possible to suppress a decrease in the residual value of the vehicle while suppressing excessive maintenance.

### EMBODIMENT

Hereinafter, an embodiment of the present disclosure will be described with reference to the drawings. The configurations of the following embodiments are illustrative, and the present disclosure is not limited to the configurations of the embodiments.

### Overview of Vehicle Management System

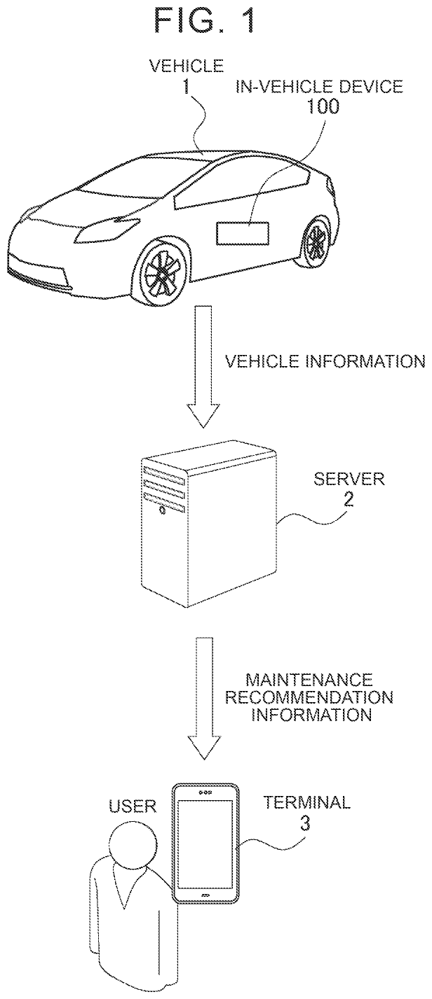

A vehicle management system to which the information processing device according to the present disclosure is applied will be described with reference to FIG. 1. FIG. 1 is a diagram illustrating an outline of a vehicle management system. The vehicle management system according to the present embodiment includes an in-vehicle device 100 mounted on the vehicle 1, a server 2, and a terminal 3 used by a user of the vehicle 1. The server 2 is connected to the in-vehicle device 100 and the terminal 3 through a network N1 described later. In the example illustrated in FIG. 1, only one vehicle 1 under the management of the server 2 is illustrated, but a plurality of vehicles may be used. 25

The vehicle 1 is a vehicle in which a user is granted usage rights by paying a fixed usage fee periodically (for example, every month). In the present embodiment, the lease contract for the vehicle 1 includes a contract in which maintenance (vehicle inspection, inspection, maintenance, and the like) during the lease period is received without an additional fee. The in-vehicle device 100 is mounted on the vehicle 1, and is configured to periodically transmit vehicle information to the server 2. In one example, the in-vehicle device 100 transmits vehicle information to the server 2 every trip (from when the start switch is turned on to when it is turned off). The vehicle information transmitted from the in-vehicle device 100 to the server 2 includes a history of the vehicle state during one trip, diagnosis information, and the like. The in-vehicle device 100 may transmit the vehicle information to the server 2 every predetermined period (several days or one month).

The server 2 is an example of an information processing device according to the present disclosure, and is operated by a lease service provider. The server 2 receives and accumulates vehicle information transmitted from the in-vehicle device 100 for each trip, and determines whether or not there is an item for which a maintenance time has arrived based on the accumulated vehicle information. When it is determined that there is an item for which a maintenance time has arrived, the server 2 determines a period (recommended time period) for which maintenance of the item is recommended. The server 2 transmits, to the terminal 3 used by the user of the vehicle 1, information (maintenance recommendation information) that prompts the user to receive the maintenance of the vehicle 1 at a predetermined station in the determined recommendation period. The predetermined station is a maintenance factory operated by the lease service provider or a maintenance factory entrusted by the lease service provider. When the user receives maintenance of the vehicle 1 at a predetermined station during the recommended time period, the server 2 determines an incentive to be provided to the user. The server 2 outputs information of the determined incentive.

### Configuration of the Vehicle Management System

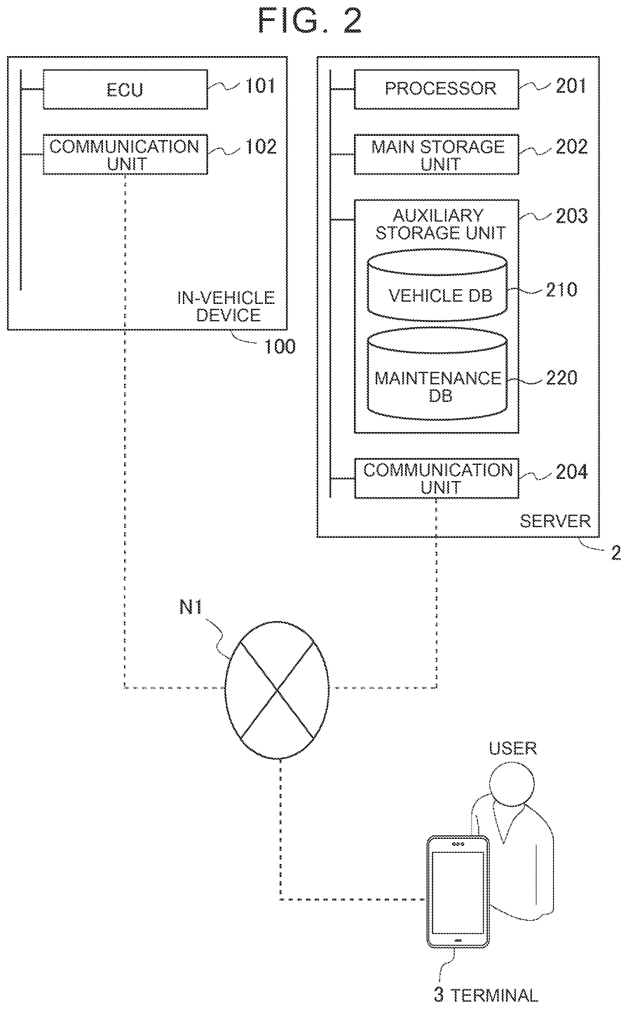

FIG. 2 is a block diagram illustrating a configuration of the in-vehicle device 100 and the server 2 included in the vehicle management system.

As illustrated in FIG. 2, the in-vehicle device 100 includes an Electronic Control Unit (ECU) 101 and a communication unit 102. ECU 101 and the communication unit 102 are connected to each other via a Controller Area Network (CAN) standard in-vehicle networking (CAN-BUS) or the like. Note that the configuration of the in-vehicle device 100 is not limited to the example illustrated in FIG. 2, and components may be omitted, replaced, or added as appropriate.

ECU 101 controls devices mounted on the vehicles 1. In the present embodiment, ECU 101 includes a plurality of ECU such as an engine ECU for controlling an engine, a motor ECU for controlling a motor, a battery ECU for controlling a battery, a hybrid ECU for controlling a hybrid system, a braking ECU for controlling braking, an air conditioner ECU for controlling an air conditioner, and an electrical ECU for controlling electrical components such as a lighting device and a wiper.

ECU 101 collects the history of the vehicle condition and the diagnosis information (abnormality diagnosis result) during the trips according to the signals of the various sensors mounted on the vehicle 1. The history of the vehicle state may include, for example, a transition of the engine rotation speed during each trip, a transition of the temperature and the pressure (hydraulic pressure) of the engine oil, a transition of the battery voltage, a transition of the operating state of the brake, a transition of the operating state of the air conditioner, a travel distance, and the like. The diagnosis information may include, for example, information for identifying an in-vehicle device diagnosed as an abnormality.

ECU 101 triggers the termination of each trip of the vehicle 1 (switching of the start switch from on to off), and transmits vehicle information including the history of the vehicle status and the diagnosis information collected during each trip to the server 2 through the communication unit 102, which will be described later. The vehicle information may include the date and time of each trip (the trip start date and time and the trip end date and time). Further, the vehicle information may include identification information (vehicle ID) of the vehicle 1.

The communication unit 102 is an interface for connecting the in-vehicle device 100 to a network N1. In one embodiment, the communication unit 102 connects to a network N1 using a radio communication network and communicates with the server 2 through a network N1. The radio communication network is, for example, a mobile communication network such as 5th-Generation (5G) or Long Term Evolution (LTE), or a Wi-Fi. The network N1 may be, for example, a Wide Area Network (WAN) that is a global public communication network such as the Internet, or another communication network.

Next, as illustrated in FIG. 2, the server 2 includes a processor 201, a main storage unit 202, an auxiliary storage unit 203, and a communication unit 204. Note that the configuration of the server 2 is not limited to the example illustrated in FIG. 2, and may include an input/output device in addition to the processor 201, the main storage unit 202, the auxiliary storage unit 203, and the communication unit 204.

The processor 201 is, for example, Central Processing Unit (CPU) or Digital Signal Processor (DSP). The processor 201 loads a program stored in the auxiliary storage unit 203 into a work area of the main storage unit 202 and executes the program, thereby realizing a function that matches a predetermined purpose. In the present embodiment, the processor 201 that executes a program stored in the auxiliary storage unit 203 corresponds to a control unit according to the present disclosure.

The main storage unit 202 is a computer-readable recording medium. In the present embodiment, the main storage unit 202 is used as a work area for loading a program stored in the auxiliary storage unit 203, and is used as a buffer for temporarily storing calculation results and the like of the processor 201. The main storage unit 202 includes, for example, Random Access Memory (RAM) and Read Only Memory (ROM).

The auxiliary storage unit 203 is a computer-readable recording medium. In the present embodiment, the auxiliary storage unit 203 stores various programs to be executed by the processor 201, various data used when the processor 201 executes the various programs, and the like. The auxiliary storage unit 203 includes, for example, Erasable Programmable ROM (EPROM) or Hard Disk Drive (HDD). The auxiliary storage unit 203 may include a removable medium, that is, a portable recording medium. The program stored in the auxiliary storage unit 203 includes, in addition to Operating System (OS), a program for implementing functions such as determination of whether or not there is an item for which a maintenance time has arrived, determination of a recommended time period, notification of a recommended time period to a user, and determination of an incentive to be provided to a user who has received maintenance of the vehicle 1 during the recommended time period. Note that some or all of the information stored in the auxiliary storage unit 203 may be stored in the main storage unit 202.

As illustrated in FIG. 2, various databases such as a vehicle DB 210 and a maintenance DB 220 are constructed in the auxiliary storage unit 203 in the present embodiment. These databases are constructed by the processor 201 executing the program of Database Management System (DBMS).

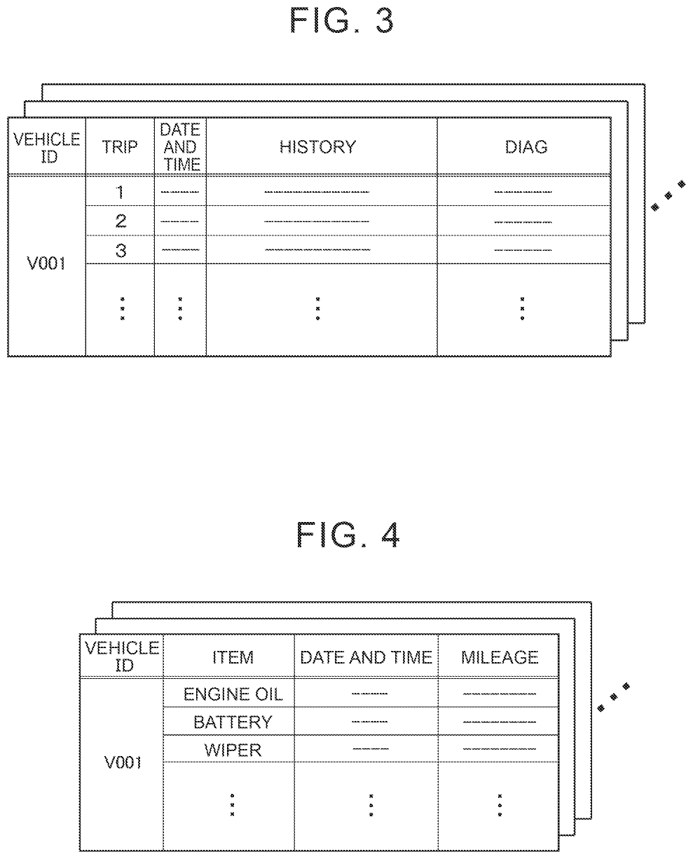

The vehicle DB 210 is a database for storing vehicle data transmitted from the vehicle 1 to the server 2. As illustrated in FIG. 3, the vehicle DB 210 includes a plurality of tables corresponding to the plurality of vehicles managed by the server 2. In the respective tables, the vehicle ID of the corresponding vehicle 1 is stored, and a plurality of records are stored for each trip of the corresponding vehicle 1. In the example illustrated in FIG. 3, each record includes a date and time field in which the date and time of each trip (the trip start date and time and the trip end date and time) is registered, a history field in which the history of the vehicle state collected in each trip is stored, a diagnosis field in which the diagnosis information collected in each trip is registered, and the like. Each time the communication unit 204 of the server 2 receives the vehicle information transmitted from the in-vehicle device 100 of the vehicle 1, a new record is added to the tables stored in the vehicle DB 210, and the history and the diagnosis information of the vehicle status included in the received vehicle information are registered in the new record.

The maintenance DB 220 is a data base for storing maintenance data performed on the vehicles 1. As illustrated in FIG. 4, the maintenance DB 220 includes a plurality of tables corresponding to a plurality of vehicles managed by the server 2. In the respective tables, the vehicle ID of the corresponding vehicle 1 is stored, and a plurality of records are stored for each of the maintenance items that are compatible with the corresponding vehicle 1. In the example illustrated in FIG. 4, each record includes an item field in which the contents of the item to be maintained are registered, a date and time field in which the date and time when the maintenance of each item is last performed is registered, a travel distance field in which the travel distance of the vehicle 1 at the time when the maintenance of each item is last performed is registered, and the like. The information registered in the date and time field and the travel distance field of each item is updated every time the vehicle 1 receives maintenance at a predetermined station.

The updating of the information registered in the date and time field and the travel distance field of the respective records in the maintenance DB 220 may be performed, for example, with acceptance of a maintenance completion notification from a predetermined station as a trigger. The maintenance completion notification at that time may include identification information (vehicle ID) of the target vehicle 1, the content of the items to be maintained, the maintenance execution date and time, the travel distance of the vehicle 1 at the time when the maintenance is performed, and the like. The above-described information may be updated by an operator who has received a maintenance completion notification from a predetermined station.

Next, the communication unit 204 of the server 2 is an interface for connecting the server 2 to a network N1. In one embodiment, the communication unit 204 is configured to include a Local Area Network (LAN) interface board, wireless communication circuitry for wireless communication, and the like. In the present embodiment, the communication unit 204 communicates with the in-vehicle device 100 and the terminal 3 through a network N1.

In the server 2 configured as described above, when the communication unit 204 receives the vehicle information transmitted from the in-vehicle device 100, the processor 201 executes the following processing through execution of the program stored in the auxiliary storage unit 203. First, the processor 201 identifies a table corresponding to the vehicle 1 by accessing the vehicle DB 210 using the vehicle ID included in the vehicle data as an argument. The processor 201 adds a new record to the identified table, and registers the history and the diagnosis information of the vehicle state included in the vehicle information in the new record. Subsequently, the processor 201 determines, based on the information stored in the vehicle DB 210 and the maintenance DB 220, whether there is an item for which the maintenance time has arrived among the items for the maintenance corresponding to the vehicle 1.

Here, referring to the engine oil, the processor 201 accesses the maintenance DB 220 to identify a table corresponding to the vehicle 1 (a table in which the vehicle ID corresponding to the vehicle ID of the vehicle 1 is registered). The processor 201 identifies a record registered as “engine oil” in the item field in the identified table. The processor 201 obtains information registered in the date and time field of the identified record (the date and time when the engine oil was last replaced). The processor 201 accesses the vehicle DB 210 to identify a table corresponding to the vehicle 1. The processor 201 identifies, in the identified table, a record of trips since the date and time when the engine oil was last replaced. The processor 201 determines whether the degree of deterioration of the engine oil exceeds a predetermined threshold based on the information registered in the history field of the identified record. As an example, if the cumulative value of the time during which the engine is operated at the engine oil temperature equal to or higher than the predetermined temperature and the engine rotational speed equal to or higher than the predetermined speed is longer than the predetermined time length in all trips after the date and time when the engine oil is last replaced, the processor 201 determines that the degree of deterioration of the engine oil exceeds the predetermined threshold value.

The method of determining whether the degree of deterioration of the engine oil exceeds a predetermined threshold value is not limited to the above-described example, and may be determined by other known methods. For example, in the last trip of the vehicle 1, if the oil pressure when the engine oil temperature is within the predetermined temperature range and the engine rotation speed is within the predetermined rotation speed range is less than the predetermined pressure, the processor 201 may determine that the degree of deterioration of the engine oil exceeds the predetermined threshold. In addition, for items other than the engine oil, the degree of deterioration may be determined by a known method.

Further, the processor 201 may determine whether there is an in-vehicle device in which the maintenance time has arrived based on the diagnosis information in the last trip of the vehicle 1. For example, if the diagnosis information in the last trip includes the identification information of the in-vehicle device diagnosed as abnormal, the processor 201 may determine that the maintenance time of the in-vehicle device has arrived.

When it is determined that there is an item for which a maintenance time has arrived, the processor 201 determines a recommended time period in which the maintenance of the item is recommended. As an example, the recommended time period may be determined according to an item in which a maintenance time has arrived. That is, the priority order among a plurality of items may be set in advance, and the higher the priority order, the earlier the recommended time period may be determined. In this case, the priority may be set to be high for items related to important safety parts and items having a high degree of influence on the remaining price of the vehicle 1 (for example, items that induce performance degradation of in-vehicle devices). In addition, in the maintenance of the in-vehicle device diagnosed as abnormal in the abnormality diagnosis, the priority according to the type of the in-vehicle device may be determined in advance, and the higher the priority, the higher the recommended time period may be determined.

The processor 201 transmits, to the terminal 3 of the user of the vehicle 1, information (maintenance recommendation information) prompting the user to receive the maintenance of the vehicle 1 at a predetermined station during the determined recommendation period. The maintenance incentive information may include information indicating that an incentive is provided here when the maintenance of the vehicle 1 is received at a predetermined station within the recommended time period. This makes it easier for the user to be motivated to receive maintenance of the vehicle 1 at a predetermined station within the recommended time period.

Here, when the user who has received the maintenance recommendation information through the terminal 3 receives the maintenance of the vehicle 1 at a predetermined station, a maintenance completion notification is transmitted from the predetermined station to the server 2 (or the operator of the server 2). The maintenance completion notification includes the vehicle ID of the vehicle 1 that has received the maintenance, the content of the items to be maintained, the maintenance execution date and time, the travel distance of the vehicle 1 at the time when the maintenance is performed, and the like. The processor 201 of the server 2 that has received the notification updates the maintenance DB 220 based on the notification content.

The processor 201 of the server 2 determines whether the maintenance execution date and time included in the notification is within the recommended time period. When it is determined that the maintenance execution date and time is within the recommended time period, the processor 201 outputs information of an incentive (reward) provided to the user of the vehicle 1. Outputting the incentive information may include presenting the incentive information to the operator through the input/output device of the server 2, presenting the incentive information to the user through the terminal 3, and presenting the incentive information to the lease service provider through the terminal of the lease service provider.

The incentive may be any incentive as long as the user can be motivated to receive maintenance of the vehicle 1 at a predetermined station within the recommended time period. As an example, the incentive may be a discount on the lease fee. As another example, the incentive may be a coupon, a point, a gift certificate, or the like.

In addition, the size of the incentive (for example, the discount rate of the lease fee, the size of the benefit that can be received by the coupon, the amount of the point, the amount of the commodity that can be exchanged by the gift certificate, and the like) may be a predetermined size. Alternatively, the size of the incentive may be determined according to the date on which the user receives the maintenance of the vehicle 1 during the recommended time period (for example, the date on which the vehicle 1 is stored at a predetermined station or the date on which the maintenance is completed) or the item on which the maintenance is performed.

In an example, the processor 201 may increase the incentive as the date on which the user receives the maintenance of the vehicle 1 at a predetermined station is closer to a specific date (recommended date) within the recommended time period. The recommended date may be the date determined voluntarily by the lease service provider, the date on which a given station can accept maintenance (the date on which the work schedule is free), the first day of the recommended time period, or the last day of the recommended time period. In addition, the recommended date may be set to an earlier date during the recommended time period as the urgency of the item for maintenance is higher. The recommended date may be flexibly changed according to the embodiment.

The incentive determination method is not limited to the above-described example, and can be flexibly changed according to the embodiment. For example, the processor 201 may increase the incentive as the importance of the maintenance item received by the vehicle 1 at a predetermined station within the recommended time period increases. The importance may be an importance level in the security standard, a degree corresponding to the degree of influence on the remaining price of the vehicle 1 (the greater the degree of importance increases as the degree of influence increases), or a degree corresponding to the price of the parts to be replaced with the maintenance (the higher the price, the greater the importance level, or the lower the price, the greater the importance level). Further, the processor 201 may increase the incentive as the number of times the user has actually received the maintenance of the vehicle 1 at a predetermined station within the recommended time period in the past increases.

### Processing Flow

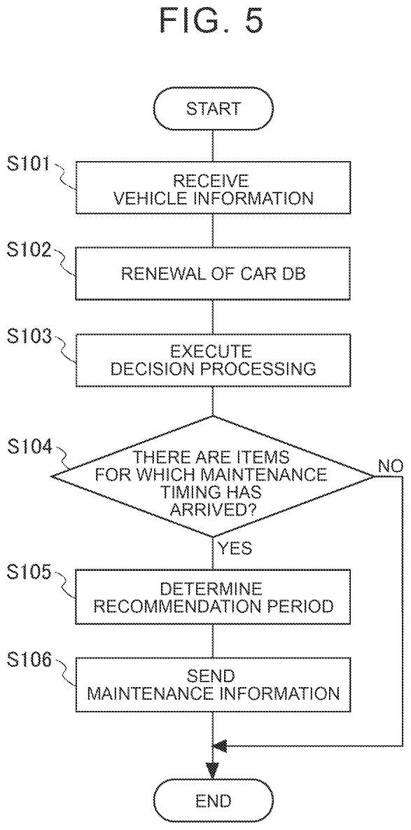

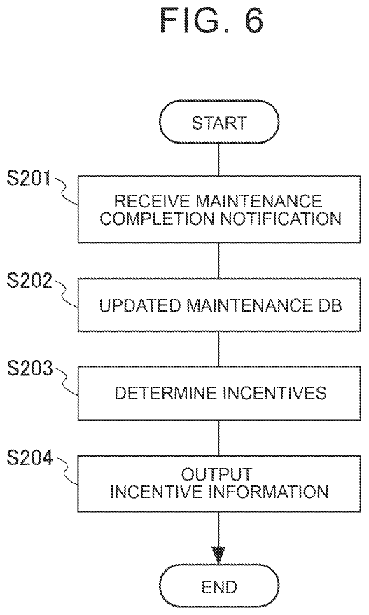

A flow of processing executed by the server 2 in the present embodiment will be described with reference to FIG. 5 and FIG. 6. FIG. 5 is a flowchart illustrating a process flow executed by the server 2 triggered by reception of vehicle information transmitted from the vehicle 1. FIG. 6 is a flowchart illustrating a process flow executed by the server 2 with the reception of the maintenance completion notification as a trigger.

In FIG. 5, the processor 201 receives vehicle data transmitted from the vehicle 1 through the communication unit 204 (S101). The processor 201 that has received the vehicle-information executes S102 process.

In S102, the processor 201 accesses the vehicle DB 210 using the vehicle ID included in the vehicle data as an argument, and identifies a table of the vehicle 1. The processor 201 adds a new record to the specified table, and registers information (trip date and time, history of vehicle state, and diagnosis information) included in the vehicle information in the corresponding field of the new record. When the processor 201 finishes executing S102 process, it executes S103 process.

In S103, the processor 201 determines, based on the information stored in the vehicle DB 210 and the maintenance DB 220, whether there is an item for which the maintenance time has arrived among the maintenance items corresponding to the vehicle 1. As an example, the processor 201 first accesses the maintenance DB 220 using the vehicle ID included in the vehicle information received by S101 as an argument, and identifies a table corresponding to the vehicle 1. The processor 201 identifies, in the identified table, a record of the maintenance item of interest. The processor 201 acquires information registered in the date and time field of the specified record (the date and time when the maintenance of the target item was last performed).

The processor 201 accesses the vehicle DB 210 to identify a table corresponding to the vehicle 1. The processor 201 identifies, in the identified table, a record of a trip after the date and time when the maintenance of the target maintenance item was last performed. The processor 201 determines, based on the information registered in the history field of the identified record, whether the degree of deterioration of the vehicle component corresponding to the target maintenance item exceeds a predetermined threshold. When it is determined that the degree of deterioration of the vehicle component corresponding to the target item exceeds the predetermined threshold value, the processor 201 determines that the maintenance time of the item has arrived.

The above determination is executed for all items registered in the item field of the table of the maintenance DB 220.

Further, the processor 201 determines, based on the diagnosis information included in the vehicle information received by S101, whether or not there is an in-vehicle device whose maintenance time has arrived. At this time, if the identification information of the in-vehicle device diagnosed as abnormal is included in the above-described diagnosis information, the processor 201 determines that the maintenance time of the in-vehicle device has arrived.

When it is determined that there are no items (or in-vehicle devices) whose maintenance time has arrived in S104 (negative determination), the processor 201 ends the process of FIG. 5. On the other hand, when it is determined that there are items (or in-vehicle devices) whose maintenance time has arrived in S104 (affirmative determination), the processor 201 executes S105 process.

S105 determines a period (recommended time period) during which maintenance of items (or in-vehicle devices) determined to have arrived at a maintenance time in S104 is recommended. As an example, the processor 201 determines the recommended time period at an earlier time as the priority of the items determined to have arrived at the maintenance time is higher. Further, with respect to the maintenance of the in-vehicle device diagnosed as abnormal in the abnormality diagnosis, the processor 201 determines the recommended time period at an earlier time as the priority according to the type of the target in-vehicle device is higher. When the processor 201 finishes executing S105 process, it executes S106 process.

In S106, the processor 201 transmits the maintenance-promotion information to the terminal 3 of the user of the vehicle 1 through the communication unit 204. The maintenance recommendation information is information for prompting the vehicle 1 to be maintained at a predetermined station within the recommendation period determined by S105. When the processor 201 finishes executing S106 process, it finishes executing the process of FIG. 5.

Next, a process in a case where the server 2 receives a maintenance completion notification from a predetermined station will be described with reference to FIG. 6. In FIG. 6, the processor 201 receives a maintenance-completion notification transmitted from a predetermined station through the communication unit 204 (S201). Upon receiving the maintenance-completion notification, the processor 201 executes S202 process.

In S202, the processor 201 updates the information of the maintenance DB 220 based on the information included in the maintenance completion notification. Specifically, the processor 201 accesses the maintenance DB 220 using the vehicle ID included in the maintenance completion notification as an argument, and specifies a table corresponding to the target vehicle 1. The processor 201 identifies, among the records of the identified table, a record that matches the contents of the maintenance item included in the maintenance completion notification. The processor 201 changes the information registered in the date and time field and the travel distance field of the specified record to the maintenance execution date and time and the travel distance included in the maintenance completion notification. When the processor 201 finishes executing S202 process, it executes S203 process.

In S203, the processor 201 determines an incentive to be provided to the user of the vehicle 1. Specifically, the processor 201 determines whether the maintenance execution date and time included in the maintenance completion notification is within the recommended time period determined in the processing flow of FIG. 5. At this time, the recommended time period determined in the processing flow of FIG. 5 may be stored in the auxiliary storage unit 203 of the server 2 in a form associated with the vehicle 1 and the item of maintenance to be performed. If the maintenance date and time is within the recommended time period, the processor 201 determines the incentive to a predetermined fixed size (>0). The processor 201 may change the size of the incentive in accordance with the date on which the user has received the maintenance of the vehicle 1, the item that has been subjected to the maintenance, or the result of the number of times the user has received the maintenance of the vehicle 1 at a predetermined station within the recommended time period in the past. In addition, when the maintenance execution date and time is outside the recommended time period, the processor 201 determines the incentive to be 0 (the incentive is not provided to the user). When the processor 201 finishes executing S203 process, it executes S204 process.

In S204, the processor 201 outputs the incentive-information determined in S203. In an example, the processor 201 may present the incentive information to the operator through the input/output device of the server 2. In another example, the processor 201 may transmit the incentive information to the terminal 3 (present to the user) or may transmit the incentive information to the terminal of the lease service provider (present to the lease service provider) through the communication unit 204. When the processor 201 finishes executing S204 process, the process of FIG. 6 ends.

According to the above-described embodiment, it is possible to arouse the user the willingness to receive maintenance of the vehicle 1 within the recommended time period. Accordingly, it is possible to suppress a decrease in the residual value of the vehicle 1 while suppressing excessive maintenance.

### MODIFIED EXAMPLES

In the above-described embodiment, an example has been described in which the size of the incentive is determined every time the user receives the maintenance of the vehicle 1 at a predetermined station, but the size of the incentive may be determined at the end of the lease period (at the time of returning the vehicle 1).

In the above-described embodiment, the server 2 is configured by one computer, but may be configured by a plurality of computers connected to each other via a network N1. That is, the processes of the server 2 described in the above-described embodiments may be shared and executed by a plurality of computers connected to each other via a network N1.

What is claimed is:

1. An information processing device comprising: a control unit configured to execute
acquiring of a recommended time period for a leased vehicle that is recommended to undergo maintenance at a predetermined station;
transmitting of information including the recommended time period to a terminal associated with a user of the leased vehicle; and
outputting of information of a reward provided to the user when maintenance of the leased vehicle is performed at the predetermined station within the recommended time period.

2. The information processing device according to claim 1, wherein:
the recommended time period includes a recommended date on which the leased vehicle is recommended to undergo maintenance at the predetermined station; and
the control unit is configured to further execute increasing of the reward the closer a date, on which the leased vehicle undergoes maintenance at the predetermined station, is to the recommended date.

3. The information processing device according to claim 1, wherein the control unit is configured to further execute increasing of the reward the greater a record of a count of times, of the leased vehicle undergoing maintenance at the predetermined station, within the recommended time period, is.

4. The information processing device according to claim 1, wherein the control unit is configured to further execute increasing of the reward the higher a degree of importance of an item of maintenance, which the leased vehicle undergoes at the predetermined station, within the recommended time period, is.

5. The information processing device according to claim 1, wherein acquisition of the recommended time period includes determining whether a degree of deterioration of vehicle components respectively corresponding to a plurality of items for maintenance exceeds a predetermined threshold value, in accordance with a vehicle state periodically acquired from the leased vehicle, and
determining the recommended time period for the item corresponding to a vehicle part of which the degree of deterioration exceeds the predetermined threshold.
